(19) United States
(12) Patent Application Publication
(10) Pub. No.: US 2025/0378825 A1
(43) Pub. Date: Dec. 11, 2025

(54) AUGMENTING CONFORMERS WITH STRUCTURED STATE-SPACE SEQUENCE MODELS FOR ONLINE SPEECH RECOGNITION

(71) Applicant: GOOGLE LLC, Mountain View, CA (US)

(72) Inventors: Haozhe SHAN, Cambridge, MA (US); Albert GU, Pittsburgh, PA (US); Zhong MENG, Jersey City, NJ (US); Weiran WANG, San Jose, CA (US); Krzysztof CHOROMANSKI, Lincroft, NJ (US); Tara N. SAINATH, Jersey City, NJ (US)

(73) Assignee: GOOGLE LLC, Mountain View, CA (US)

(21) Appl. No.: 18/734,803

(22) Filed: Jun. 5, 2024

(51) Int. Cl. G10L 15/16

(52) U.S. Cl. CPC G10L 15/16

(57) ABSTRACT

A method, device, and computer-readable storage medium for generating a text representation of a speech sample, including receiving an audio sample, encoding the audio sample based on left context of the audio sample with a structured state-space sequence model and a conformer, the structured state-space sequence model being initialized with a diagonal matrix of recurrent weights and trained with a set of training data, decoding the encoded audio sample, and generating a transcript of the audio sample based on the decoding.

### BACKGROUND

### Field of the Disclosure

The present disclosure relates to encoding of speech data.

### Description of the Related Art

Automatic Speech Recognition (ASR) is a field of technology enabling electronic devices and systems to process an inputted audio sample or signal, the audio sample including spoken language. ASR can include, for example, a determination of a text representation of spoken language. The text representation can then be processed for meaning using natural language processing (NLP) systems.

The foregoing “Background” description is for the purpose of generally presenting the context of the disclosure. Work of the inventors, to the extent it is described in this background section, as well as aspects of the description which may not otherwise qualify as prior art at the time of filing, are neither expressly or impliedly admitted as prior art against the present disclosure.

### SUMMARY

The foregoing paragraphs have been provided by way of general introduction and are not intended to limit the scope of the following claims. The described embodiments, together with further advantages, will be best understood by reference to the following detailed description taken in conjunction with the accompanying drawings.

In one embodiment, the present disclosure is related to a method for generating a text representation of a speech sample, comprising: receiving, via processing circuitry, an audio sample; encoding, via the processing circuitry, the audio sample based on left context of the audio sample with a structured state-space sequence model and a conformer, the structured state-space sequence model being initialized with a diagonal matrix of recurrent weights and trained with a set of training data; decoding, via the processing circuitry, the encoded audio sample; and generating, via the processing circuitry, a transcript of the audio sample based on the decoding.

In one embodiment, the present disclosure is related to a device comprising: processing circuitry configured to receive an audio sample, encode the audio sample based on left context of the audio sample with a structured state-space sequence model and a conformer, the structured state-space sequence model being initialized with a diagonal matrix of recurrent weights and trained with a set of training data, decode the encoded audio sample, and generate a transcript of the audio sample based on the decoding.

In one embodiment, the present disclosure is related to a non-transitory computer-readable storage medium for storing computer-readable instructions that, when executed by a computer, cause the computer to perform a method, the method comprising: receiving an audio sample; encoding the audio sample based on left context of the audio sample with a structured state-space sequence model and a conformer, the structured state-space sequence model being initialized with a diagonal matrix of recurrent weights and trained with a set of training data; decoding the encoded audio sample; and generating a transcript of the audio sample based on the decoding.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic of a conformer, according to an embodiment of the present disclosure;

FIG. 2 is a schematic of augmented conformer architecture, according to an embodiment of the present disclosure;

FIG. 3 illustrates automatic speech recognition performance of an encoder, according to an embodiment of the present disclosure;

FIG. 4 illustrates automatic speech recognition performance of an encoder, according to an embodiment of the present disclosure;

FIG. 5 illustrates automatic speech recognition performance of an encoder, according to an embodiment of the present disclosure;

FIG. 6 illustrates automatic speech recognition performance of an encoder, according to an embodiment of the present disclosure;

FIG. 7 illustrates automatic speech recognition performance of an encoder, according to an embodiment of the present disclosure;

FIG. 8 illustrates automatic speech recognition performance of an encoder, according to an embodiment of the present disclosure;

FIG. 9 is a method of generating a text representation of speech, according to an embodiment of the present disclosure;

FIG. 10 is a schematic of a user device for performing a method, according to an embodiment of the present disclosure;

FIG. 11 is a schematic of a hardware system for performing a method, according to an embodiment of the present disclosure; and

FIG. 12 is a schematic of a hardware configuration of a device for performing a method, according to an embodiment of the present disclosure.

### DETAILED DESCRIPTION

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

In one embodiment, the present disclosure is directed to systems and methods for encoding audio data for Automatic Speech Recognition (ASR). An encoder-decoder pair can be used for ASR to generate a text representation (e.g., a transcript) from speech. The encoder can be trained to process and extract features from the audio data. The decoder can be trained to generate a text output based on the features encoded by the encoder. The encoded features can be representations of the audio data. In one embodiment, the encoded features can include feature sequences or a feature state.

In one embodiment, the systems and methods described herein can be used for real-time ASR to generate live speech transcriptions with high accuracy. Real-time speech encoding and decoding (also referred to as live ASR or online ASR) presents specific challenges in the required speed of processing as well as the available context that can be used for processing the speech. A live speech sample only includes past utterances as context (also referred to as left context) that can be used to encode present utterances. There is no future context because the speech is being encoded and transcribed as it is being input to an encoder. In contrast, a prerecorded (“offline”) speech sample can be encoded using both past utterances and future utterances. For example, when an encoder is processing a certain utterance in the middle of a prerecorded speech sample, the encoder can use utterances preceding the certain utterance (left context) as well as utterances following the certain utterance (right context) to encode the certain utterance.

In one embodiment, a device can train an encoder to encode speech and can use the encoder to process an audio sample. The processing of the speech sample can include audio data processing and transformation, encoding of the audio sample, decoding of a representation of the audio sample, generation of a text representation of speech in the audio sample, etc. The device can be an electronic device including, but not limited to, a mobile device (phone), a computer or tablet, or a wearable device. In one embodiment, the electronic device can be a consumer device, such as a television or vehicle, or an appliance such as a smart speaker or screen that can be configured for audio (voice)-activated functions.

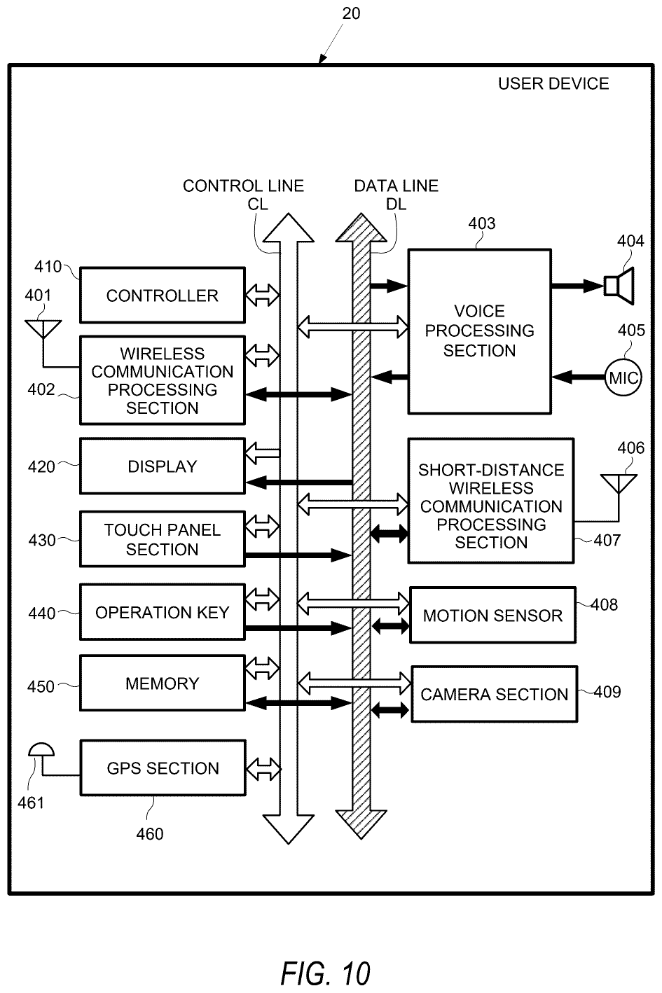

In one embodiment, the device as referred to herein can be a networked electronic device, such as a computer or a server, that can perform ASR functions for client devices (second devices). A client device can be an electronic device that records or receives an inputted audio sample, such as a mobile device, a wearable device, a consumer device, an appliance, etc. The client device can transmit the audio sample to the networked device over a network connection, and the networked device can process the audio sample using the ASR techniques described in the present disclosure. The networked device can transmit an output to the client device in response to the audio sample. The output can include a transcription of the audio sample or a data intermediate that can be used to process and respond to the audio sample. Examples of the electronic devices, including networked devices, and client devices, can include the hardware devices described herein with reference to FIG. 10 through FIG. 12 or any of the components thereof. Each of the electronic devices can include processing circuits/processing circuitry, the processing circuitry including one or more of: processors, controllers, programmed processing units (e.g., central processing units (CPUs)), integrated circuits, etc. Examples of processing circuitry and components thereof are further described herein with reference to FIGS. 10-12. The processes and methods described herein can be executed by processing circuitry in the described devices, e.g., by a CPU or a controller (or other circuitry) of an electronic device. The processing circuitry can implement machine learning models, such as an encoder and decoder, in order to process data for ASR as described herein. In one embodiment, the methods and models described herein can be executed by processing circuitry of a single device, e.g., the networked device. In one embodiment, the methods and models described herein can be executed by more than one device. For example, processing circuitry of a first networked device can encode audio data and transmit the encoded audio data to a second networked device. Processing circuitry of the second networked device can decode the encoded audio data.

In one embodiment, the encoder can include one or more neural network architectures. In one embodiment, the encoder can include a state-space model in combination with a conformer. A state-space model maps an input signal to an output signal using a system of equations. The system can be a linear, time-invariant system that can be represented by linear ordinary differential equations (ODEs) or convolutional operations. The input signal and the output signal can be one-dimensional, e.g., continuous functions of time or data that is recorded over time. The state-space model can map a one-dimensional input signal to a multidimensional (N-dimensional) intermediate state via one or more matrices (parameters). The intermediate state is then mapped to the one-dimensional output signal.

In digital audio processing, audio data can be discrete, e.g., a sequence of inputs collected over time. The discrete input uₖ can be mapped to an intermediate state xₖ, and the intermediate state xx can be mapped to a discrete output yₖ via a discretized state-space model. In one embodiment, the state-space model of the encoder can be discretized according to the following set of equations:

$$\begin{matrix}{x}_{k} = \overline{A} {x}_{k - 1} + \overline{B} {u}_{k} \\ {y}_{k} = {Cx}_{k} + {Du}_{k}\end{matrix}$$

The parameters Ā, B̅, C, and D can be trainable matrices of weights, wherein Ā and B̅ are discrete approximations of continuous functions. The matrices Ā and B̅ can be dependent on a time step size. In one embodiment, Ā can be a matrix of recurrent weights, B̅ can be a matrix of input weights, C can be a matrix of readout weights, and D can be a matrix of residual weights. For an input sequence uₖ being a one-dimensional array having length (or height) H, the parameters can have the following dimensions: Ā can be an N×N matrix, B̅ can be an N×H matrix, C can be an H×N matrix, and D can be an H×H matrix. In one embodiment, the elements of each of the matrices Ā, B̅, and C can be complex numbers, while the elements of the matrix D can be real numbers. The values of the matrices can be parameterized, or determined and set based on model training.

A discretized state-space model can be represented as a convolutional operation y=u*K̅, wherein K̅ is a T×H convolution kernel that can be defined as K̅=[CB̅, CĀB̅, . . . CĀ^{-T-1}B̅]. In one embodiment, the convolution kernel K̅ can be used to match an input of any length. In one embodiment, the recurrent matrix Ā can present a computational bottleneck in parameterizing the model and convolving an input by the kernel K̅ for each entry of uₖ. Such a bottleneck can be especially problematic for live ASR.

Therefore, in one embodiment, the state-space model of the present disclosure can be a structured state-space sequence (“S4”) model, wherein the recurrent matrix Ā can be initialized and parameterized as a complex diagonal matrix. The use of a diagonal matrix can reduce the computational complexity of convolution with the kernel K̅. In one embodiment, the recurrent matrix Ā can be constrained such that values of Ā are bounded on at least one side. Specifically, in one embodiment, the real part of Ā can be bounded on at least one side to be wholly negative. For example, the real values of Ā can be defined by an exponential function or an activation function (e.g., a rectified linear unit, softplus function, etc.). Constraining the real part of Ā can ensure that the kernel K̅ always has a solution as t approaches infinity.

In one embodiment, the encoder can be initialized and then parameterized via a training process in order to determine the values of the weighting matrices Ā, B̅, C, and D. In one embodiment, the recurrent matrix Ā can be initialized as a complex N×N diagonal matrix. The matrix Ā thus has 2N complex entries along the diagonal that can be parameterized. In one embodiment, the matrix Ā can be initialized such that the nth diagonal entry is defined as

$${A}_{n}^{l i n} = - \frac{1}{2} + i π n ( n = 0 , 1 , … , N - 1 ) .$$

In one embodiment, the real and imaginary parts can both be parameterized. In one embodiment, the real part can be constrained during parameterization with a non-positive function. An example of a non-positive function can be Re(Aₙ)=−exp (xₙ), wherein xₙ can be a parameter.

In one embodiment, the matrix Ā can be initialized as a real-valued N×N diagonal matrix having 2N real entries along the diagonal that can be trained. In one embodiment, the nth diagonal entry of Ā can be initialized as

$${A}_{n}^{r e a l} = - n - 1 ( n = 0 , 1 , … , N ) .$$

In one embodiment, the input weight matrix B̅ can be initialized such that each value of B̅=1. In one embodiment, the input weight matrix B̅ can be frozen and the matrix C can be determined during training in order to parameterize the product CB̅. In one embodiment, the matrices B̅ and C can both be parameterized. In one embodiment, a real-valued diagonal matrix can be effective for initialization when the inputs to the encoder model are real-valued.

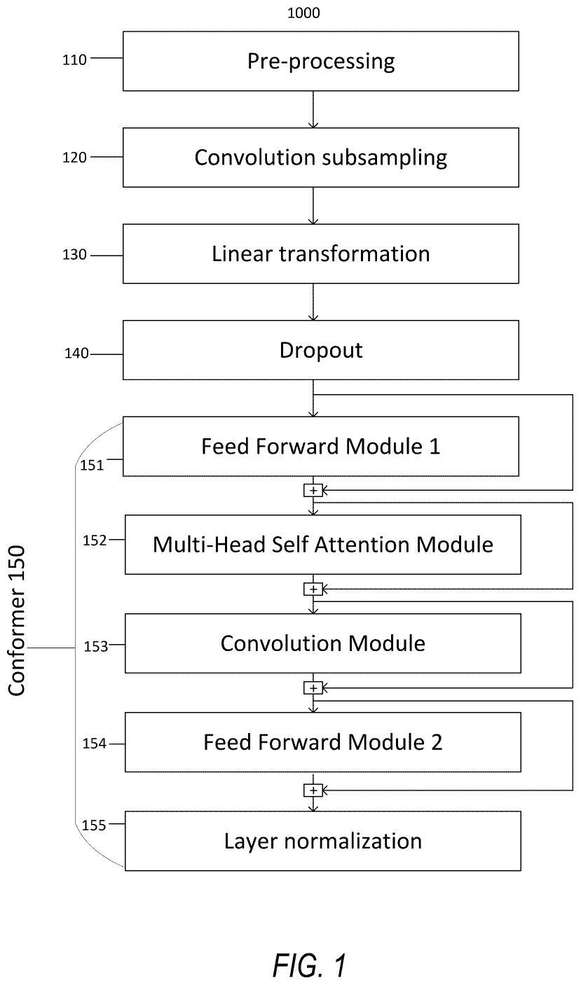

In one embodiment, the S4 model can be used to augment a base encoder model. In one embodiment, the base encoder model can be a convolution-augmented transformer, or a conformer. FIG. 1 is a schematic of a base encoder architecture according to one embodiment. The base encoder model 1000 can include a pre-processing layer 110, a convolutional subsampling layer 120, a linear transformation layer 130, and a dropout layer 140. The base encoder model 1000 can include one or more conformer modules (layers) 150, wherein each of the one or more conformer modules can include a first feed-forward module 151, a self-attention module 152, a convolution module 153, a second feed-forward module 154, and a layer normalization layer 155. In one embodiment, the self-attention module of the conformer can utilize multi-head self-attention (MHSA) with relative positional embedding. In MHSA, an attention model can be applied to multiple portions of the input in parallel. The portions of the input can have different lengths, resulting in more robust encoding and improved handling of long-term (long context) dependency in the input data. In one embodiment, the conformer can have approximately 119 M parameters, 17 layers, and 8 attention heads. In one embodiment, a convolution kernel size can be 32. The encoder dimension can be 512 with relative positional embedding. The hyperparameters of the conformer can be tuned in addition to the parameterization of S4 weights until a certain accuracy (e.g., a word error rate (WER)) is achieved.

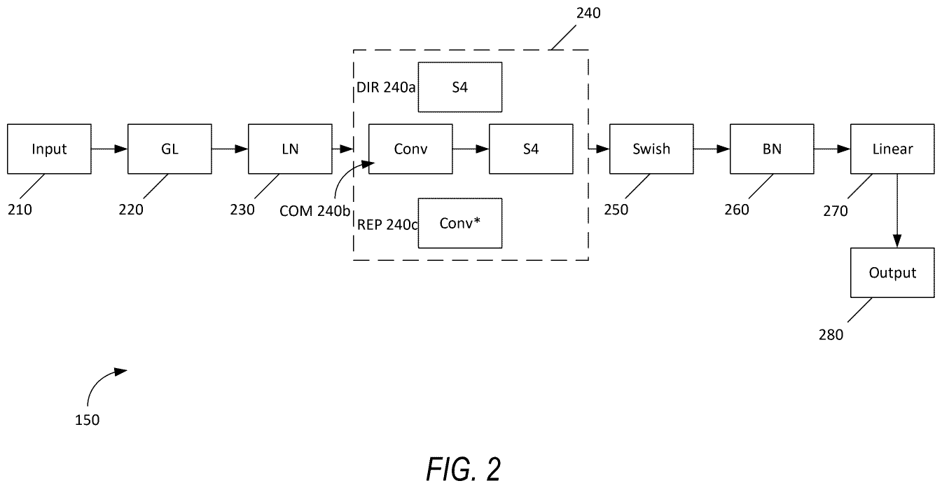

FIG. 2 is a schematic of conformer augmentations according to one embodiment. In one embodiment, an input 210 to the conformer 150 can be input to a gated linear transformation (GL) layer 220 and a layer normalization (LN) layer 230. The output of the LN layer 230 can then be passed through an augmented convolution module 240. The output of the augmented convolution module 240 can be input to a swish function 250 and then a batch normalization (BN) layer 260. The output of the BN layer 260 can be input to a second linear transformation layer 270 and then output 280.

In one embodiment, the convolution module 240 of FIG. 2 can be augmented by an S4 model. Additionally or alternatively, the S4 model can be used to augment other layers in the base encoder model or can be stacked with other layers in base encoder model. The resulting augmented conformer can be the encoder used by the device in the ASR methods described herein.

In one embodiment, the S4 model can utilize left context. The left context can vary from a short or limited amount of left context to long left context or unlimited left context with good performance. In one example, long left context can be within a range of 1000 to 16000 steps, or approximately 30 seconds of audio data. In this manner, a conformer module that is augmented with the addition of the S4 model can process an input using long left or unlimited left context and long-term dependency. The performance of the S4 model with left context can present an advantage over traditional transformer or conformer architectures, which focus on local dependency. In one embodiment, the S4 model can replace the convolution module of FIG. 1 as a drop-in replacement (DIR) architecture 240a. Specifically, application of the S4 model can replace the use of a convolution kernel in a base conformer model.

In one embodiment, the S4 model can be combined or stacked with the convolution module (convolutional network) of FIG. 1, as in the COM architecture 240b. Specifically, the S4 model can be combined with a local (e.g., small kernel size) convolution operation. In one embodiment, the convolution can precede the S4 model. Alternatively or additionally, the convolution can follow the S4 model. In one embodiment, the S4 model can be used to determine, via reparameterization (REP architecture 240c), a convolution kernel K̅ that is used in the convolution module. In one embodiment, the convolution kernel can be a finite size kernel for t input values. In one embodiment, the kernel can be parameterized as a matrix \tilde{K}(L) of size L, wherein \tilde{K}(L)=[CB̅, CĀB̅, . . . , CĀ^{L-1}B̅]. The reparameterization of the convolution kernel by the S4 model can result in a truncated kernel along the time dimension when compared with a standard convolution kernel. In one embodiment, the matrix sizes (e.g., N) of the S4 model can be truncated to generate a truncated convolution kernel. In one embodiment, the convolution module augmented by the reparameterization approach may not have additional left context. In one embodiment, the COM architecture 240b and the REP architecture 240c can be combined. For example, an S4 model can be applied in combination with convolution, and the S4 model can also be used to reparameterize the convolution kernel.

In one embodiment, the encoder (e.g., the augmented conformer) can be trained using a number of batches (B), each batch being T×H for a total input size of B×T×H. In one embodiment, the device can split a training input along a feature dimension into H one-dimensional time series. Each time series h can correspond to a feature. Each time series can be input to an S4 model to parameterize Ā^{h}, B̅^{h}, C^{h} for h=1, . . . , H. In one embodiment, the diagonal of the matrix Ā^{h} can be initialized with a complex

$$( e . g . , {A}_{n}^{l i n} = - \frac{1}{2} + i π n ( n = 0 , 1 … , N - 1 ) )$$

or real

$$( e . g . , {A}_{n}^{r e a l} = - n - 1 )$$

diagonal. In one embodiment, the encoder dimension can be H=512 and N=4, resulting in S4 models having a total of approximately 4000 parameters. In one embodiment, variational noise and feature augmentation (e.g., feature warping, masking, etc.) can be applied to the training data during training in order to prevent model overfitting.

In one embodiment, similar batch preparation (preprocessing) can be used for training and inference. The device can split an input along a feature dimension into H one-dimensional time series. Each time series can be input to a corresponding parameterized S4 model from h=1, . . . , H. In one embodiment, the device can process and divide an input audio sample into individual audio feature samples via a filterbank, e.g., an 80-channel filterbank. In one embodiment, the device can apply two layers of two-dimensional convolution subsampling to the audio feature samples. The device can then input the audio feature samples to the encoder. In one embodiment, the frame rate can be 25 Hz. In one example, the encoder can be trained with a labeled data set. In one embodiment, the encoder can be trained and tested using audio data of varying complexity, noise, etc. (e.g., “clean” data, not “clean” data). For example, the encoder can be trained and tested using Librispeech data. In one embodiment, the encoder can be trained and tested for online ASR by removing right context from the attention module and convolution modules. For example, the filter size of the convolution modules can be reduced to 16 to only address left context.

In the inference (testing) process, a device can prepare (preprocess) the input data and input the preprocessed input data to the encoder. The encoder can output feature encodings of the preprocessed input data. The device can then input the feature encodings to a decoder. The decoder can generate a speech recognition output, such as a transcription of speech in the input data. In one embodiment, the decoder can be a recurrent neural network (RNN)-Transducer model having a single-layer long short-term memory (LSTM) decoder with label-sync and frame-sync beam search with beam size 8. The transcription of speech output by the decoder can be compared to a verified transcription to determine the accuracy of the model.

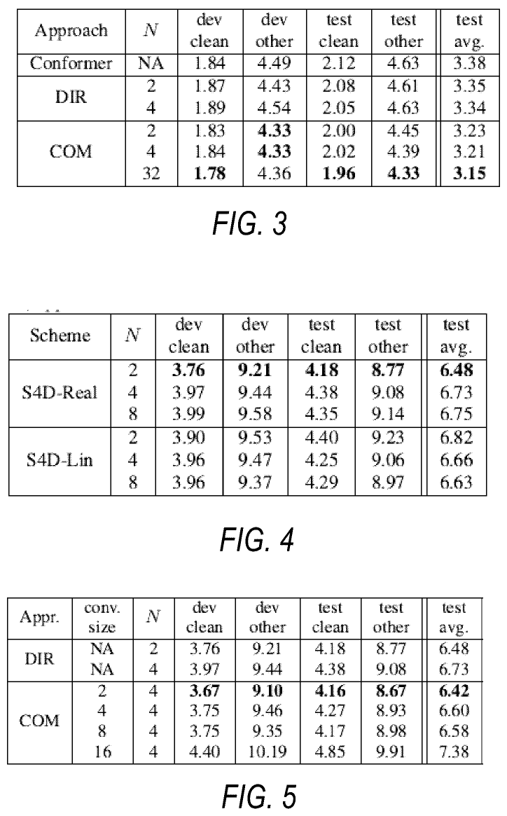

In one embodiment, varying initializations and dimensions (N) for the recurrent matrix A can be tested for each augmented conformer architecture for ASR. In one embodiment, ablation of layers or modules in the augmented conformer can be used to determine an effect of the layers or modules. FIG. 3 is an example of WER (in %) for offline ASR for a baseline Conformer, DIR architecture encoders, and COM architecture encoders having different recurrent matrix A sizes with approximately 119 M parameters. The best performance (e.g., lowest WER) for the encoder architectures is indicated in bold in FIGS. 3-8. The performance of the encoders can be assessed using development (dev) datasets and test datasets. The datasets can include clean audio as well as audio that is less clean (“other”). The length of the square A matrix can include, for example, 2, 4, 8, 16, 32, etc. In one embodiment, an encoder having a COM architecture and varying recurrent matrix Ā sizes can achieve a lower WER (in %) when compared with a baseline conformer and a DIR architecture.

FIG. 4 is an example of WER (in %) for a DIR architecture encoder that is initialized with the

$${A}_{n}^{r e a l}$$

and

$${A}_{n}^{l i n}$$

(S4D-Lin) matrices described herein. The DIR architecture encoders are used for online speech recognition. In one embodiment, the

$${A}_{n}^{r e a l}$$

(SD4-Real) initialization can result in more accurate speech recognition. In one embodiment, a smaller recurrent matrix Ā (e.g., N=2). can result in more accurate online speech recognition. This result can be in contrast with standalone S4 encoders having diagonal matrices Ā that are not combined with conformers. In one embodiment, a larger recurrent matrix can result in more accurate offline speech recognition.

FIG. 5 is an example of WER (in %) for DIR architecture and COM architecture encoders having different recurrent matrix Ā sizes. The encoders are used for online speech recognition. The recurrent matrix Ā can be initialized as

$${A}_{n}^{r e a l}$$

for each of the encoders. The convolution kernel size for the COM architecture can also be varied while maintaining unlimited left context. The stacking of convolution with the S4 model results in a reduction of WER. In one embodiment, a smaller convolution kernel size (e.g., <16, between 2 to 4) can result in more accurate speech recognition for online ASR. In one embodiment, the convolution kernel can be a 2×2 kernel. A smaller convolution kernel can be useful for capturing shorter (local) context in input data. The use of a smaller convolution kernel can complement the multi-head self-attention module, which can be useful for capturing longer contexts in data encoding. In one embodiment, the effectiveness of a smaller convolution kernel for online ASR can be in contrast with long left context that is used for offline ASR with a standard conformer. Additionally, the architectures described herein can be effective with smaller N values than would be expected for S4 models having diagonal weights, given theoretical results showing that S4 models having diagonal weights are equivalent to those having non-diagonal weights at infinite dimensions. The use of a smaller convolution kernel can result in a more adaptable ASR model. In one embodiment, a larger convolution kernel (e.g., N>4) can be more effective for offline ASR.

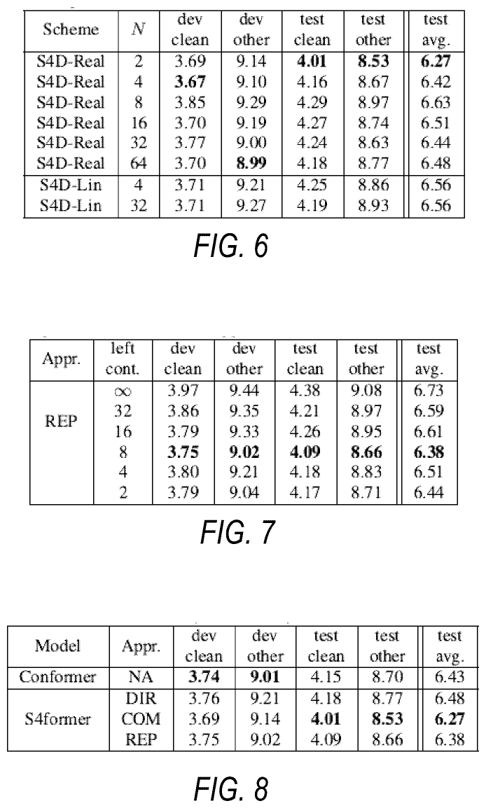

FIG. 6 is an example of WER (in %) for COM architecture encoders having different recurrent matrix Ā sizes. The encoders are used for online speech recognition. The convolution kernel for each encoder can be fixed as a 2×2 kernel. The recurrent matrix A can be initialized using

$${A}_{n}^{r e a l} or {A}_{n}^{l i n} .$$

In one embodiment, a COM architecture encoder initialized with a recurrent matrix having a small dimension can result in more accurate speech recognition.

FIG. 7 is an example of WER (in %) for REP architecture encoders having access to varying amounts of left context. The left context access can be configured by the size of the convolution kernel that is reparameterized by the S4 model. In one embodiment, the forward pass functions of the REP architecture encoder can remain the same as a baseline conformer. The finite-size reparameterized convolution kernel can be computed and cached by the device and used for convolution in the baseline conformer architecture. In one embodiment, a convolution kernel having 8 steps of left context can have the most accurate performance for online ASR. In one embodiment, the REP architecture can be effective for online ASR even with short-term dependencies.

FIG. 8 is an example of WER (in %) for DIR, COM, and REP architecture encoders (“S4formers”) compared to a conformer. The conformer can be tuned with a convolution kernel of size 4. In one embodiment, the augmented conformers can be more accurate than a standard conformer. In one embodiment, the COM architecture can have better performance than DIR and REP architectures for test data.

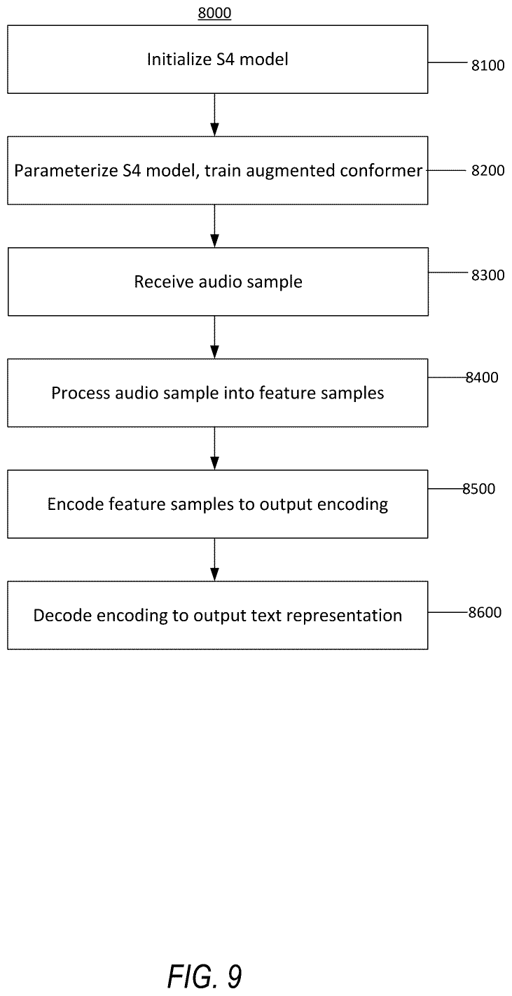

FIG. 9 is a flowchart of a method for training and using the augmented conformer as an encoder according to one embodiment of the present disclosure. The augmented conformer can include an S4 model in at least one of the DIR architecture, the CON architecture, and the REP architecture. In step 8100, the device (e.g., a server) can initialize the parameters Ā, B̅, and C of the S4 model. In one embodiment, the matrix Ā can be initialized with real values, e.g., the

$${A}_{n}^{r e a l}$$

matrix. In one embodiment, the device can set the matrix Ā as a 2×2 matrix. The device can then parameterize the S4 model using training data in step 8200 to determine values of the matrices Ā, B̅, and C. The device can train the augmented conformer as a whole using the training data. In step 8300, the device can receive an audio sample. For example, the device can record an audio sample or can receive audio data. In step 8400, the device can preprocess the audio sample, e.g., by splitting the audio sample into different feature samples. The preprocessing of the audio sample can be the same as a preprocessing of the training data. In step 8500, the device can input each feature sample to the encoder to encode the audio sample. In step 8600, the device can input the encoding of the encoder to a decoder. The decoder can output a text representation (e.g., a transcript) of the audio sample. In one embodiment, the device can perform and repeat steps 8400, 8500, and 8600 concurrently with the receiving of the audio sample in step 8300. For example, the device can receive the audio sample as a live sample. The device can preprocess, encode, and decode the audio data in real time as the device continuously receives the audio data.

The augmented conformer encoder, as described herein, can be used for accurate online ASR. A discretized S4 model can be used to access and process long left context and long-term dependencies that are not addressed by a standard conformer. The discretized S4 model can be initialized and parameterized using a small, diagonal recurrent weight matrix. The discretized S4 model can be used to augment a conformer in a number of architectures. In one embodiment, a combined or stacked S4 model with a convolutional module can improve the performance of an augmented conformer encoder.

In one example, a device can initialize and train an encoder-decoder model using a training set of speech data. The encoder can be a conformer augmented with an S4 model as described herein. The device can set parameters of the encoder, such as matrices Ā, B̅, C, D, etc. based on the training. The device can use the model to generate a live transcript of speech. The device can generate the live transcript while receiving or recording the speech. For example, the device can record audio and can input the recorded audio with left (past) context to the trained encoder-decoder model while recording. The encoder can encode the recorded audio and the decoder can decode the encoding to generate a transcript of speech in the recorded audio. The device can continuously record new audio, input the new recorded audio to the trained encoder-decoder model, and transcribe speech in the new recorded audio. In one example, the device can record audio and generate a transcript in parallel. In one example, the device can output (e.g., display) the transcript of speech, write the transcript of speech to memory, transmit the speech to a second device, etc.

In one example, the device can receive recorded audio from a client device. For example, a client device can record audio and can transmit the recorded audio to the device in real time. The device can receive the audio and input the received audio with left (past) context to the trained encoder-decoder model. The device can generate the transcript of the received audio using the trained encoder-decoder model. The device can continuously receive new audio, input the new received audio to the trained encoder-decoder model, and transcribe speech in the new received audio. In one embodiment, the device can transmit the transcript to the client device while continuing to receive and transcribe new audio data.

Embodiments of the subject matter and the functional operations described in this specification can be implemented by digital electronic circuitry, in tangibly embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of data processing apparatus, such as the electronic device, consumer device, networked electronic device, etc. The computer storage medium can be a machine-readable storage device, a machine-readable storage substrate, a random or serial access memory device, or a combination of one or more of them.

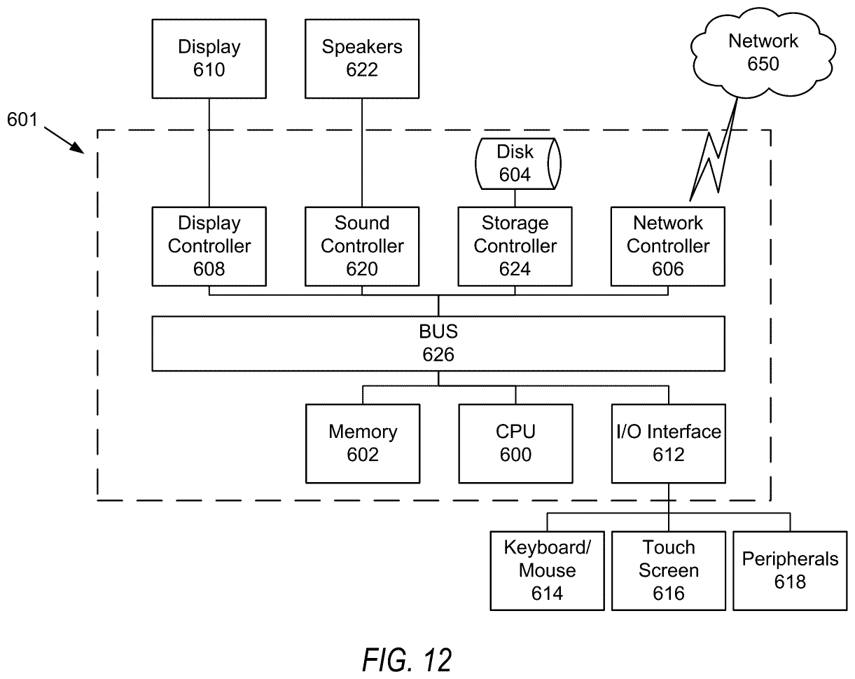

Each of the functions of the described embodiments can be implemented by one or more processing circuits/processing circuitry/processing firmware (may also be referred to as a controller). A processing circuit includes a programmed processor (for example, a CPU of FIG. 12), as a processor includes circuitry. A processing circuit can also include devices such as an application specific integrated circuit (ASIC) and circuit components arranged to perform the recited functions.

The term “data processing apparatus” refers to data processing hardware and may encompass all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, Subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA an ASIC.

Computers suitable for the execution of a computer program include, by way of example, general or special purpose microprocessors or both, or any other kind of central processing unit. Generally, a CPU will receive instructions and data from a read-only memory or a random access memory or both. Elements of a computer are a CPU for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more Such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients (user devices) and servers. A client and server are generally remote from each other and typically interact through a communication network. The relationship of client and server arises by virtue of computer programs running on the respective computers and having a client-server relationship to each other. In an embodiment, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

Electronic user device 20 shown in FIG. 10 can be an example of one or more of the devices described herein, including an electronic device configured to predict pronunciation of a text entity and a client device configured to record or receive an audio sample. In an embodiment, the electronic user device 20 may be a smartphone. However, the skilled artisan will appreciate that the features described herein may be adapted to be implemented on other devices (e.g., a laptop, a tablet, a server, an e-reader, a camera, a navigation device, etc.). The user device 20 of FIG. 10 includes processing circuitry, as discussed above. The processing circuitry includes one or more of the elements discussed next with reference to FIG. 10. The electronic user device 20 may include other components not explicitly illustrated in FIG. 10 such as a CPU, GPU, frame buffer, etc. The electronic user device 20 includes a controller 410 and a wireless communication processor 402 connected to an antenna 401. A speaker 404 and a microphone 405 are connected to a voice processor 403.

The controller 410 may include one or more processors/processing circuitry (CPU, GPU, or other circuitry) and may control each element in the user device 20 to perform functions related to communication control, audio signal processing, graphics processing, control for the audio signal processing, still and moving image processing and control, and other kinds of signal processing. The controller 410 may perform these functions by executing instructions stored in a memory 450. Alternatively or in addition to the local storage of the memory 450, the functions may be executed using instructions stored on an external device accessed on a network or on a non-transitory computer readable medium.

The memory 450 includes but is not limited to Read Only Memory (ROM), Random Access Memory (RAM), or a memory array including a combination of volatile and non-volatile memory units. The memory 450 may be utilized as working memory by the controller 410 while executing the processes and algorithms of the present disclosure. Additionally, the memory 450 may be used for long-term storage, e.g., of image data and information related thereto.

The user device 20 includes a control line CL and data line DL as internal communication bus lines. Control data to/from the controller 410 may be transmitted through the control line CL. The data line DL may be used for transmission of voice data, displayed data, etc.

The antenna 401 transmits/receives electromagnetic wave signals between base stations for performing radio-based communication, such as the various forms of cellular telephone communication. The wireless communication processor 402 controls the communication performed between the user device 20 and other external devices via the antenna 401. For example, the wireless communication processor 402 may control communication between base stations for cellular phone communication.

The speaker 404 emits an audio signal corresponding to audio data supplied from the voice processor 403. The microphone 405 detects surrounding audio and converts the detected audio into an audio signal. The audio signal may then be output to the voice processor 403 for further processing. The voice processor 403 demodulates and/or decodes the audio data read from the memory 450 or audio data received by the wireless communication processor 402 and/or a short-distance wireless communication processor 407. Additionally, the voice processor 403 may decode audio signals obtained by the microphone 405.

The user device 20 may also include a display 420, a touch panel 430, an operation key 440, and a short-distance communication processor 407 connected to an antenna 406. The display 420 may be a Liquid Crystal Display (LCD), an organic electroluminescence display panel, or another display screen technology. In addition to displaying still and moving image data, the display 420 may display operational inputs, such as numbers or icons which may be used for control of the user device 20. The display 420 may additionally display a GUI for a user to control aspects of the user device 20 and/or other devices. Further, the display 420 may display characters and images received by the user device 20 and/or stored in the memory 450 or accessed from an external device on a network. For example, the user device 20 may access a network such as the Internet and display text and/or images transmitted from a Web server.

The touch panel 430 may include a physical touch panel display screen and a touch panel driver. The touch panel 430 may include one or more touch sensors for detecting an input operation on an operation surface of the touch panel display screen. The touch panel 430 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus may include a conductive material at least at the tip of the stylus such that the sensors included in the touch panel 430 may detect when the stylus approaches/contacts the operation surface of the touch panel display (similar to the case in which a finger is used for the touch operation).

In certain aspects of the present disclosure, the touch panel 430 may be disposed adjacent to the display 420 (e.g., laminated) or may be formed integrally with the display 420. For simplicity, the present disclosure assumes the touch panel 430 is formed integrally with the display 420 and therefore, examples discussed herein may describe touch operations being performed on the surface of the display 420 rather than the touch panel 430. However, the skilled artisan will appreciate that this is not limiting.

For simplicity, the present disclosure assumes the touch panel 430 is a capacitance-type touch panel technology. However, it should be appreciated that aspects of the present disclosure may easily be applied to other touch panel types (e.g., resistance-type touch panels) with alternate structures. In certain aspects of the present disclosure, the touch panel 430 may include transparent electrode touch sensors arranged in the X-Y direction on the surface of transparent sensor glass.

The touch panel driver may be included in the touch panel 430 for control processing related to the touch panel 430, such as scanning control. For example, the touch panel driver may scan each sensor in an electrostatic capacitance transparent electrode pattern in the X-direction and Y-direction and detect the electrostatic capacitance value of each sensor to determine when a touch operation is performed. The touch panel driver may output a coordinate and corresponding electrostatic capacitance value for each sensor. The touch panel driver may also output a sensor identifier that may be mapped to a coordinate on the touch panel display screen. Additionally, the touch panel driver and touch panel sensors may detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. For example, in an embodiment, the touch panel 430 may detect a position of a user's finger around an edge of the display panel 420 (e.g., gripping a protective case that surrounds the display/touch panel). Signals may be transmitted by the touch panel driver, e.g. in response to a detection of a touch operation, in response to a query from another element based on timed data exchange, etc.

The touch panel 430 and the display 420 may be surrounded by a protective casing, which may also enclose the other elements included in the user device 20. In an embodiment, a position of the user's fingers on the protective casing (but not directly on the surface of the display 420) may be detected by the touch panel 430 sensors. Accordingly, the controller 410 may perform display control processing described herein based on the detected position of the user's fingers gripping the casing. For example, an element in an interface may be moved to a new location within the interface (e.g., closer to one or more of the fingers) based on the detected finger position.

Further, in an embodiment, the controller 410 may be configured to detect which hand is holding the user device 20, based on the detected finger position. For example, the touch panel 430 sensors may detect fingers on the left side of the user device 20 (e.g., on an edge of the display 420 or on the protective casing), and detect a single finger on the right side of the user device 20. In this example, the controller 410 may determine that the user is holding the user device 20 with his/her right hand because the detected grip pattern corresponds to an expected pattern when the user device 20 is held only with the right hand.

The operation key 440 may include one or more buttons or similar external control elements, which may generate an operation signal based on a detected input by the user. In addition to outputs from the touch panel 430, these operation signals may be supplied to the controller 410 for performing related processing and control. In certain aspects of the present disclosure, the processing and/or functions associated with external buttons and the like may be performed by the controller 410 in response to an input operation on the touch panel 430 display screen rather than the external button, key, etc. In this way, external buttons on the user device 20 may be eliminated in lieu of performing inputs via touch operations, thereby improving watertightness.

The antenna 406 may transmit/receive electromagnetic wave signals to/from other external apparatuses, and the short-distance wireless communication processor 407 may control the wireless communication performed between the other external apparatuses. Bluetooth, IEEE 802.11, and near-field communication (NFC) are non-limiting examples of wireless communication protocols that may be used for inter-device communication via the short-distance wireless communication processor 407.

The user device 20 may include a motion sensor 408. The motion sensor 408 may detect features of motion (i.e., one or more movements) of the user device 20. For example, the motion sensor 408 may include an accelerometer to detect acceleration, a gyroscope to detect angular velocity, a geomagnetic sensor to detect direction, a geo-location sensor to detect location, etc., or a combination thereof to detect motion of the user device 20. In an embodiment, the motion sensor 408 may generate a detection signal that includes data representing the detected motion. For example, the motion sensor 408 may determine a number of distinct movements in a motion (e.g., from start of the series of movements to the stop, within a predetermined time interval, etc.), a number of physical shocks on the user device 20 (e.g., a jarring, hitting, etc., of the electronic device), a speed and/or acceleration of the motion (instantaneous and/or temporal), or other motion features. The detected motion features may be included in the generated detection signal. The detection signal may be transmitted, e.g., to the controller 410, whereby further processing may be performed based on data included in the detection signal. The motion sensor 408 can work in conjunction with a Global Positioning System (GPS) section 460. The information of the present position detected by the GPS section 460 is transmitted to the controller 410. An antenna 461 is connected to the GPS section 460 for receiving and transmitting signals to and from a GPS satellite.

The user device 20 may include a camera section 409, which includes a lens and shutter for capturing photographs of the surroundings around the user device 20. In an embodiment, the camera section 409 captures surroundings of an opposite side of the user device 20 from the user. The images of the captured photographs can be displayed on the display panel 420. A memory section saves the captured photographs. The memory section may reside within the camera section 109 or it may be part of the memory 450. The camera section 409 can be a separate feature attached to the user device 20 or it can be a built-in camera feature.

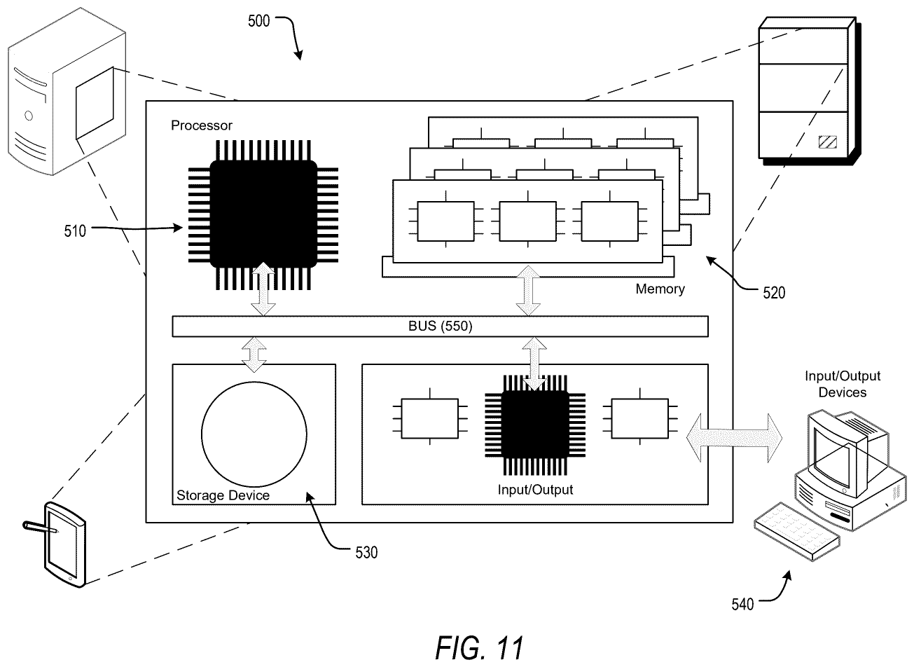

An example of a type of computer is shown in FIG. 11. The computer 500 can be used for the operations described in association with any of the computer-implement methods described previously, according to one implementation. For example, the computer 500 can be an example of an electronic device, such as a computer or mobile device, or a networked device such as a server. The processing circuitry includes one or more of the elements discussed next with reference to FIG. 11. In FIG. 11, the computer 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the computer 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the computer 500. In one implementation, the storage device 530 is a computer-readable medium. In various different implementations, the storage device 530 may be a floppy disk device, a hard disk device, an optical disk device, or a tape device.

The input/output device 540 provides input/output operations for the computer 500. In one implementation, the input/output device 540 includes a keyboard and/or pointing device. In another implementation, the input/output device 540 includes a display unit for displaying graphical user interfaces.

Next, a hardware description of a device 601 according to the present embodiments is described with reference to FIG. 12. In FIG. 12, the device 601, which can be any of the above described devices, including the electronic devices and the networked devices, includes processing circuitry. The processing circuitry includes one or more of the elements discussed next with reference to FIG. 12. The process data and instructions may be stored in memory 602. These processes and instructions may also be stored on a storage medium disk 604 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device 601 communicates, such as a server or computer.

Further, the claimed advancements may be provided as a utility application, background daemon, or component of an operating system, or combination thereof, executing in conjunction with CPU 600 and an operating system such as Microsoft Windows, UNIX, Solaris, LINUX, Apple MAC-OS and other systems known to those skilled in the art.

The hardware elements in order to achieve the device 601 may be realized by various circuitry elements, known to those skilled in the art. For example, CPU 600 may be a Xenon or Core processor from Intel of America or an Opteron processor from AMD of America, or may be other processor types that would be recognized by one of ordinary skill in the art. Alternatively, the CPU 600 may be implemented on an FPGA, ASIC, PLD or using discrete logic circuits, as one of ordinary skill in the art would recognize. Further, CPU 600 may be implemented as multiple processors cooperatively working in parallel to perform the instructions of the processes described above.

The device 601 in FIG. 12 also includes a network controller 606, such as an Intel Ethernet PRO network interface card from Intel Corporation of America, for interfacing with network 650. and to communicate with the other devices. As can be appreciated, the network 650 can be a public network, such as the Internet, or a private network such as an LAN or WAN network, or any combination thereof and can also include PSTN or ISDN sub-networks. The network 650 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The device 601 further includes a display controller 608, such as a NVIDIA Geforce GTX or Quadro graphics adaptor from NVIDIA Corporation of America for interfacing with display 610, such as an LCD monitor. A general purpose I/O interface 612 interfaces with a keyboard and/or mouse 614 as well as a touch screen panel 616 on or separate from display 610. General purpose I/O interface also connects to a variety of peripherals 618 including printers and scanners.

A sound controller 620 is also provided in the device 601 to interface with speakers/microphone 622 thereby providing sounds and/or music.

The general purpose storage controller 624 connects the storage medium disk 604 with communication bus 626, which may be an ISA, EISA, VESA, PCI, or similar, for interconnecting all of the components of the device 601. A description of the general features and functionality of the display 610, keyboard and/or mouse 614, as well as the display controller 608, storage controller 624, network controller 606, sound controller 620, and general purpose I/O interface 612 is omitted herein for brevity as these features are known.

While this specification contains many specific implementation details, these should not be construed as limitations on the scope of what may be claimed, but rather as descriptions of features that may be specific to particular embodiments.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Embodiments of the present disclosure may also be set forth in the following parentheticals.

(1) A method for generating a text representation of a speech sample, comprising receiving, via processing circuitry, an audio sample; encoding, via the processing circuitry, the audio sample based on left context of the audio sample with a structured state-space sequence model and a conformer, the structured state-space sequence model being initialized with a diagonal matrix of recurrent weights and trained with a set of training data; decoding, via the processing circuitry, the encoded audio sample; and generating, via the processing circuitry, a transcript of the audio sample based on the decoding.

(2) The method of (1), wherein the structured state-space sequence model is preceded by a convolutional network of the conformer.

(3) The method of (1) to (2), wherein the structured state-space sequence model replaces a convolutional network of the conformer.

(4) The method of (1) to (3), wherein a convolutional kernel of the conformer is based on parameterization of the structured state-space sequence model.

(5) The method of (1) to (4), wherein the diagonal matrix of recurrent weights is a real-valued matrix.

(6) The method of (1) to (5), wherein the diagonal matrix of recurrent weights includes complex numbers.

(7) The method of (1) to (6), wherein the diagonal matrix of recurrent weights is a 2×2 matrix.

(8) A device comprising processing circuitry configured to receive an audio sample, encode the audio sample based on left context of the audio sample with a structured state-space sequence model and a conformer, the structured state-space sequence model being initialized with a diagonal matrix of recurrent weights and trained with a set of training data, decode the encoded audio sample, and generate a transcript of the audio sample based on the decoding.

(9) The device of (8), wherein the structured state-space sequence model is preceded by a convolutional network of the conformer.

(10) The device of (8) to (9), wherein the structured state-space sequence model replaces a convolutional network of the conformer.

(11) The device of (8) to (10), wherein a convolutional kernel of the conformer is based on parameterization of the structured state-space sequence model.

(12) The device of (8) to (11), wherein the diagonal matrix of recurrent weights is a real-valued matrix.

(13) The device of (8) to (12), wherein the diagonal matrix of recurrent weights includes complex numbers.

(14) A non-transitory computer-readable storage medium for storing computer-readable instructions that, when executed by a computer, cause the computer to perform a method, the method comprising receiving an audio sample; encoding the audio sample based on left context of the audio sample with a structured state-space sequence model and a conformer, the structured state-space sequence model being initialized with a diagonal matrix of recurrent weights and trained with a set of training data; decoding the encoded audio sample; and generating a transcript of the audio sample based on the decoding.

(15) The non-transitory computer-readable storage medium of (14), wherein the structured state-space sequence model is preceded by a convolutional network of the conformer.

(16) The non-transitory computer-readable storage medium of (14) to (15), wherein the structured state-space sequence model replaces a convolutional network of the conformer.

(17) The non-transitory computer-readable storage medium of (14) to (16), wherein a convolutional kernel of the conformer is based on parameterization of the structured state-space sequence model.

(18) The non-transitory computer-readable storage medium of (14) to (17), wherein the diagonal matrix of recurrent weights is a real-valued matrix.

(19) The non-transitory computer-readable storage medium of (14) to (18), wherein the diagonal matrix of recurrent weights includes complex numbers.

(20) The non-transitory computer-readable storage medium of (14) to (19), wherein the diagonal matrix of recurrent weights is a 2×2 matrix.

Thus, the foregoing discussion discloses and describes merely example embodiments of the present disclosure. As will be understood by those skilled in the art, the present disclosure may be embodied in other specific forms without departing from the spirit thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

1. A method for generating a text representation of a speech sample, comprising:
receiving, via processing circuitry, an audio sample;
encoding, via the processing circuitry, the audio sample based on left context of the audio sample with a structured state-space sequence model and a conformer, the structured state-space sequence model being initialized with a diagonal matrix of recurrent weights and trained with a set of training data;
decoding, via the processing circuitry, the encoded audio sample; and
generating, via the processing circuitry, a transcript of the audio sample based on the decoding.

2. The method of claim 1, wherein the structured state-space sequence model is preceded by a convolutional network of the conformer.

3. The method of claim 1, wherein the structured state-space sequence model replaces a convolutional network of the conformer.

4. The method of claim 1, wherein a convolutional kernel of the conformer is based on parameterization of the structured state-space sequence model.

5. The method of claim 1, wherein the diagonal matrix of recurrent weights is a real-valued matrix.

6. The method of claim 1, wherein the diagonal matrix of recurrent weights includes complex numbers.

7. The method of claim 1, wherein the diagonal matrix of recurrent weights is a 2×2 matrix.

8. A device comprising:
processing circuitry configured to
receive an audio sample,
encode the audio sample based on left context of the audio sample with a structured state-space sequence model and a conformer, the structured state-space sequence model being initialized with a diagonal matrix of recurrent weights and trained with a set of training data,
decode the encoded audio sample, and
generate a transcript of the audio sample based on the decoding.

9. The device of claim 8, wherein the structured state-space sequence model is preceded by a convolutional network of the conformer.

10. The device of claim 8, wherein the structured state-space sequence model replaces a convolutional network of the conformer.

11. The device of claim 8, wherein a convolutional kernel of the conformer is based on parameterization of the structured state-space sequence model.

12. The device of claim 8, wherein the diagonal matrix of recurrent weights is a real-valued matrix.

13. The device of claim 8, wherein the diagonal matrix of recurrent weights includes complex numbers.

14. A non-transitory computer-readable storage medium for storing computer-readable instructions that, when executed by a computer, cause the computer to perform a method, the method comprising:
receiving an audio sample;
encoding the audio sample based on left context of the audio sample with a structured state-space sequence model and a conformer, the structured state-space sequence model being initialized with a diagonal matrix of recurrent weights and trained with a set of training data;
decoding the encoded audio sample; and
generating a transcript of the audio sample based on the decoding.

15. The non-transitory computer-readable storage medium of claim 14, wherein the structured state-space sequence model is preceded by a convolutional network of the conformer.

16. The non-transitory computer-readable storage medium of claim 14, wherein the structured state-space sequence model replaces a convolutional network of the conformer.

17. The non-transitory computer-readable storage medium of claim 14, wherein a convolutional kernel of the conformer is based on parameterization of the structured state-space sequence model.

18. The non-transitory computer-readable storage medium of claim 14, wherein the diagonal matrix of recurrent weights is a real-valued matrix.

19. The non-transitory computer-readable storage medium of claim 14, wherein the diagonal matrix of recurrent weights includes complex numbers.

20. The non-transitory computer-readable storage medium of claim 14, wherein the diagonal matrix of recurrent weights is a 2×2 matrix.
